(19) United States
(12) Patent Application Publication
(10) Pub. No.: US 2016/0144649 A1
(43) Pub. Date: May 26, 2016

(54) Combination Book Holder and Bookmark

(71) Applicant: Christian Julian Popowich, Calgary (CA)

(72) Inventor: Christian Julian Popowich, Calgary (CA)

(21) Appl. No.: 14/181,888

(22) Filed: Feb. 17, 2014

(51) Int. Cl. B42D 9/00

(52) U.S. Cl. CPC B42D 9/004

(57) ABSTRACT

A small clip to hold open a book, conveniently remaining in it as a marker when closed, which is unobtrusive and inexpensively made. It is a single piece metal or plastic frame consisting of a straddle plate (11) and a breech (12) which are joined and spaced apart and parallel by a bridge (13). The combination of the elements forms a housing for several pages of a book when clipped over them. When placed so that the straddle crosses the centre of an open book and the breech is near the spine (between pages below), the present invention holds open the book. When placed so that the straddle is on one side only of the book and the breech is several pages below, the book may be closed and so marked and the clip stored.

This is a continuation in part of application Ser. No. 12/535,664, filed Aug. 4, 2009, now abandoned.

A petition to Revive for Avoidable but Unintentional Delay (Rule 137(b)) is made contemporaneously.

### BACKGROUND

1. Field of Invention

The present invention relates to a retainer for holding open a book and marking a page when closed, called a combination book-holder and bookmark.

2. Description of Prior Art

Various devices are known to hold open books, but to the best of my knowledge there is no prior art book holder or retainer or clip that is as simple, small and unobtrusive, easy to use (even for those with limited dexterity or strength), effective, inexpensive and easy to construct, as the present invention is, or which like it is stored within and as a bookmark, and also may receive advertising or art.

Applicant's invention has immovable elements and is inflexible, permitting it to hold open books which do not lay flat when open or would otherwise close, such as those constructed with oversewn or perfect bindings. To applicants' knowledge, no prior art device is so capable or effective.

Books bound by machine oversewing, the strongest method of binding and used for library binding and in which the pages are sewn together, will not lay flat when opened. Machine oversewing was not invented until the first quarter of the 20^{th} Century. Books bound with perfect or case binding, in which the pages are arranged and glued together into a text block that is attached to the cover or case, will also not lay flat when opened. Perfect binding is the most common type of binding for hardcover books and for paperback books. Perfect binding was invented in 1895, but was little used for book binding until 1930s, when paperback books were introduced.

One example of a prior art device is described in the U.S. Pat. No. 316,499, dated Apr. 28, 1885, granted to Thomas for a “book holder”.

While Thomas discloses a book holder, it does not function to hold open all types of books and it is not a combination book holder and bookmark. As the Thomas part A is of spring steel or leaf metal, and is intended to operate as a spring (and is called “spring A”), it is unable to hold open a book which does not lay flat when open, such as ones constructed with oversewn or perfect bindings. The same is so with strip B of the Thomas device.

The need to overcome the force of the spring makes Thomas difficult to use for those with limited dexterity or strength. Strip B of Thomas has its ends curved upwards and so it cannot remain as a marker in a book when closed. Thomas also is comprised of at least three pieces, such that manufacturing is made more difficult and expensive than for applicant's invention, which can be made of a single piece.

Another example of a prior art device is described and illustrated in U.S. Pat. No. 126,901, dated May 21, 1872, granted to Phelps. While it holds open a book, its parts are “elastic” and are thereby intended to move relative to each other. Also, Phelps lip C is intended to enter the back crease of a book, and so will not work on books that have no such back crease, as is so with many perfect binding. In addition, the size of the book which may be held open by the Phelps invention is limited to the size of device. The need to counter the elastic nature of the device makes its operation more difficult for those with limited dexterity or strength. And the Phelps invention may not remain in the book as a mark; it is a pocket device.

Another example of such a device is described and illustrated in U.S. Pat. No. 1,188,082, date Jun. 20, 1916, granted to Knowles. It holds only the pages of one side of the book; it does not hold open a book. It is made of many pieces, and requires adjustment to attach to the book and the turning down of a rod to hold the pages. It is not of single-handed operation. It does not take advertising or art. Its complexity in use would make its operation difficult for those with limited dexterity or strength.

Another device is described and illustrated in U.S. Pat. No. 445,885, dated Feb. 3, 1891, granted to Benjamin, for a “book holder”. It is again made of spring metal, and so is not effective to hold open books which do not lay flat (e.g. ones with oversewn or perfect bindings). It cannot remain in a book as a mark, as the ends of each piece turn up. It has moving parts, and so construction is more complicated, and use is made more difficult for those with limited dexterity.

Another example of such a device is described and illustrated in U.S. Pat. No. 4,908,912, dated Mar. 20, 1990, granted to Grant for a “retainer for maintaining a book in an open position”. The device only works on books of a given thickness: for different thicknesses, a different size clip is required, and selection of the one that is the “most snug” is required for any given book, The construction is of “resilient” material to permit its flexing, and apparently is made only for light books. The device is also relatively large, it is not convenient to use, and it does not remain unobtrusively in the book as a mark when closed.

Another example of such a device is described and illustrated in U.S. Pat. No. 5,364,056, dated Nov. 15, 1994, granted to Jiang for a “Combined book holder and bookmark”. While it holds open a book and marks a page when closed, it has several disadvantages. The size of the book which can be held is limited to less than the length and width of the device. It is relatively large and cumbersome to use. It may cover text when holding open a book. A flat surface is needed to support it. It has moving parts subject to wear and tear. Construction requires manufacture and assembly of several parts. And it cannot be used with a single motion.

Another example of such a device is described and illustrated in U.S. Pat. No. 6,019,339, dated Feb. 1, 2000, granted to Brayford for a “Book Holder”. While it holds open a book, it has most of the same disadvantages; and as with other “Bookholders”, it does not mark a page in a closed book. It is relatively large also.

Another example of a device to hold open a book is described and illustrated in U.S. Pat. No. 6,733,043, dated May 11, 2004, to Silverstein for a “Bookholder”. It has most of the same disadvantages, and the book must be laid flat for the device to work.

In other types, two elements are inserted between pages on either side of the spine. They are awkward to use and obstruct text.

An example of such a device to hold open a book is described and illustrated in U.S. Pat. No. 4,932,680, dated Jun. 12, 1990, granted to Rivera for a “Book clip”. While it holds open a book, it has several disadvantages. It is awkward and relatively difficult to use in that two elements must be simultaneously inserted between pages on both sides of an open book, requiring significant manipulation and sometimes snagging. It draws the pages of an open book together at the centre, such that not all of the text is visible. It covers part of the text and must be moved to permit reading of the entire page. It is large and cannot be conveniently used as a bookmark. It must be used with the book in a standing position, not laying, and it cannot provide a means for advertising.

Another example of such a device to hold open a book is described and illustrated in U.S. Pat. No. 322,459, dated December 17, 1991, to Pimienta for an “ornamental design for a book clip”. While it holds open a book, it also has most of the same disadvantages. The requirement to insert two elements in the pages below make it awkward to use. It covers text. It has been found not to work effectively at the starting or ending pages of the book. And it is again relatively large.

Another example of such a device to hold open a book is described and illustrated in U.S. Pat. No. 6,537,796, dated Mar. 19, 2002, to Halstead for a “smooth book clip”. It suffers also from most of the same disadvantages, and is not receptive of art or advertising.

Other unsuitable devices, most often intended for other purposes, have been used to hold open a book: paperweights, staplers, tape holders, books, ashtrays, dishes etc. These have some or all of the disadvantages of the above-noted types.

Patents have also been issued for bookmarks, as described and illustrated in U.S. Pat. No. 3,090,347, dated May 21, 1963 to Harnett, for a “bookmark”. It is not made to hold the book open: it is only a bookmark. It also has two separate areas into which pages need be inserted, increasing the complexity of use. It is intended also to be made of clear material, as it covers text—and so it may not take art or advertising. It is intended also for use on hardcover books, and will not operate on those of soft or flexible covers. The present invention is a combination book holder and bookmark, works on all manner of books, is simpler to operate, and does not obscure text.

### OBJECTS AND ADVANTAGES

It is desirable to have a device to hold open books, whether of hard or soft cover construction, and including those with perfect or oversewn bindings (or other construction by which the book does not lay flat when open), that is easily used with a single motion, is small and unobtrusive, is stored in the book and marks a page, allows the book to be stood on end, held or laid in a flat position, and is of single piece construction and inexpensive to make and therefore purchase. The present invention provides these advantages and overcomes the disadvantages of the prior art.

The present invention is a small inflexible metal (or other material) device which straddles the opposing pages of an open book and is clipped over several leaves, on one or the other side of the book, by means of a breech and bridge to keep the device in place near the center fold, thereby holding open the book, and which remains as a mark in the book when closed. It functions on all sizes and manners of books, whether constructed with hard or soft covers, and including those with perfect or oversewn bindings.

The present invention has only one element to be inserted within the pages of an open book, and so can be readily and easily used in a single motion with the book in virtually any position. It needs not be inserted down the spine; and takes very little force to use. It is unobtrusive and does not cover the book's text. Text or art may be put on it for advertising or aesthetics.

### DRAWING FIGURES

The present invention, as exemplified by a preferred embodiment, is described with reference to the Drawings in which:

FIGS. 1 and 2 show perspective views of the obverse and reverse sides of the device;

FIGS. 3 and 4 show the device holding open a book and remaining in it as a marker when closed.

### REFERENCE NUMERALS

In the Drawings, the following reference numerals are used:

11 Straddle

12 Breech

13 Bridge

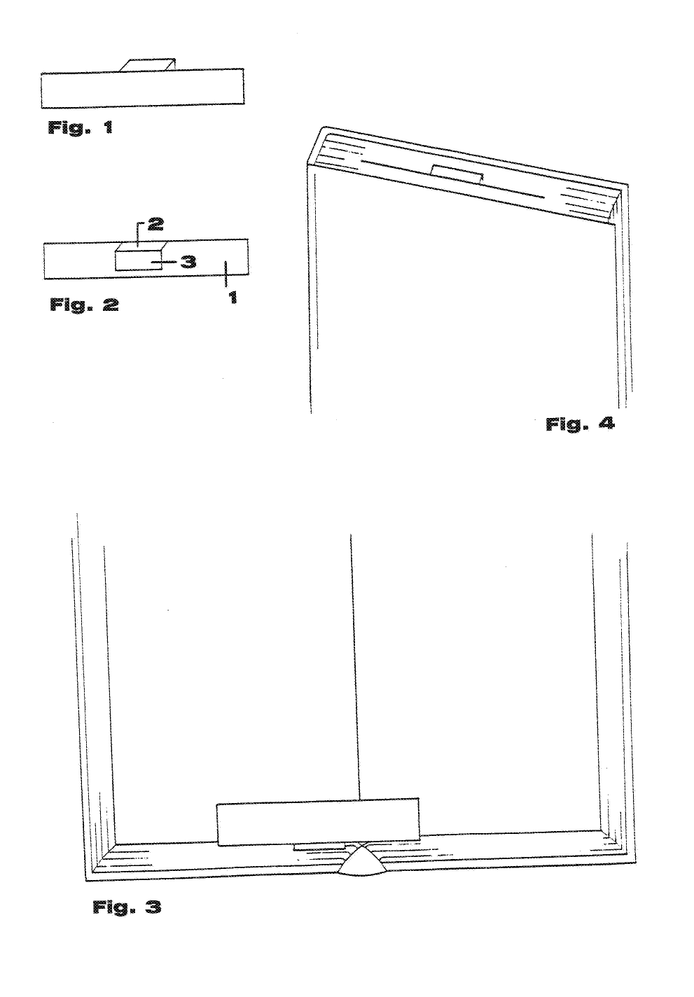

### DESCRIPTION OF INVENTION—FIGS. 1 and 2

The present invention comprises a frame, having a straddle plate 11 and breech 12 parallel thereto which is spaced from and spanned by a bridge 13.

The straddle crosses the centre of an open book and is held on the open pages by the breech, inserted several leaves below, on one side or the other, and placed near the spine. The breech is parallel to and spaced apart from the straddle plate at a distance sufficient to sandwich and house several leaves between the inner sides of the breech and straddle plate. The breech and straddle plate are joined by a bridge, which spans the edges of a book's leaves so sandwiched. None of the elements move in operation or when in place: the breech and straddle do not spread apart or splay.

The present invention may be made of thin sheet metal which can be cut or stamped and bent into the shape of the device and remain in that shape so as to keep the breech and straddle from being spread apart or splayed (by the force predisposing to some books to close, such as those made with oversewn or perfect bindings). The present invention may also be made of plastic or other material that can be moulded, extruded, cut and bent, or otherwise made into the shape and form of the device, and, stay in that shape.

Although only a single embodiment of the present invention has been described and illustrated, the present invention is not limited to the features of this embodiment. There are various additional possibilities with regard to: the relative disposition of the bridge and breech to the straddle; the sizes and shapes of the straddle, bridge, and breech; and of the method of joining the straddle, bridge and breech (as by hinge that can lock and release the elements, for example); and of the material(s) of manufacture and texture thereof.

### Operation of Invention—FIGS. 3 and 4

The present invention is operated by (1) sandwiching several leaves of one side of an open book, top or bottom, between the straddle and breech, and (2) then sliding it so that the straddle crosses the book's centre and is held on the open pages by the breech, inserted several leaves below and placed near the centrefold. The book will then remain open because the opposing pages are held down and apart by the straddle, and the straddle is held secure from lifting by the breech which is several leaves below. The bridge joins the straddle and breech, and, the elements being inflexible and immovable, prevents them from splaying apart.

FIG. 3 is of the present invention holding open a book.

The book and its leaves are released for turning by lifting off the device. The book may be closed by sliding the device back away from the centre so that it is on one side only. It may so remain in the book when closed, marking the page and being ready to hand.

FIG. 4 is of the present invention remaining in a closed book as a marker.

The present invention has been found to function effectively with all manner of books, irrespective of construction or size, and including those that by their construction exert force to close or will not lay open (e.g. ones with oversewn or perfect bindings).

Another feature of this invention is that text or art may be put on its face for esthetic purposes, advertisement, identification etc.

I claim:

1. A device for holding open a book and remaining in it as a marker when closed, comprising:
a transverse straddle;
a breech spaced apart and parallel thereto; and
a bridge to span and join the straddle and breech.
which forms a housing for several leaves of a book and thus a retainer for an open book when positioned so that the straddle is across the book's centre and the breech is several leaves below near the spine, as well as a mark when positioned on one side only of a closed book, made of thin inflexible material, the elements of which are immovable.

2. The device of claim 1, the straddle or breech of which are arced or bent inwards for increased adherence to the leaves of the book.

3. The device of claim 1, the inner sides or edges of which have a coating or material, such as latex or rubber, for increased adherence to the leaves of the book.

4. The device of claim 1, the inner sides or edges of which are textured for increased adherence to the leaves of the book.

5. The device of claim 1, the elements of which are joined so that they are held immovable unless manually caused or permitted to open and close for insertion over the leaves.
